(19) United States
(12) Patent Application Publication
(10) Pub. No.: US 2003/0073404 A1
(43) Pub. Date: Apr. 17, 2003

(54) Non-geostationary satellite communication system and satellite, station and terminal included therein

(75) Inventors: Anne Sauvageot, Paris (FR); Denis Rouffet, Boulogne Billancourt (FR); Didier Casasoprana, St Germain En Laye (FR); Cyril Michel, Paris (FR); Laurent Combarel, Paris (FR)

Correspondence Address: SUGHRUE MION, PLLC, 2100 Pennsylvania Avenue, NW, Washington, DC, 20037-3213, US

(73) Assignee: ALCATEL ESPACE

(21) Appl. No.: 10/290,338

(22) Filed: Nov. 8, 2002

Related U.S. Application Data
(63) Continuation of application No. 08/574,309, filed on Dec. 18, 1995, now abandoned.

(30) Foreign Application Priority Data
Jun. 12, 1995 (FR) 95 06930
Oct. 3, 1995 (FR) 95 11616

(51) Int. Cl. H04B 7/185

(52) U.S. Cl. 455/13.1; 455/429

(57) ABSTRACT

A communication system includes a set of non-geostationary satellites setting up communication links between ground stations and terminals, the links from a station terminating at associated terminals in a limited geographical area including the station. A communication link between a particular station and the associated terminals is set up by a satellite of the set of satellites. The satellite is commanded to set up for this purpose a steerable transmit beam and a steerable receive beam pointing at the limited area including the particular station and supporting the communication link.

### BACKGROUND OF THE INVENTION

1. Field of the Invention

The present invention concerns a communication system comprising a set of non-geostationary satellites providing communication links between ground stations and fixed terminals on the ground, a communication link from a station terminating at associated terminals in a limited geographical area including that station.

2. Description of the Prior Art

A system of this type is described in the article “GLOBALSTAR: un système transparent” (“GLOBALSTAR: a transparent system”) by D. Rouffet published in la Revue des Télécommunications, first quarter 1993, and in the documents cited in the bibliography of the article.

In the system described in the above document the terminals are mobile rather than fixed. They have an omnidirectional antenna and communicate with the satellite(s) providing them with the strongest signal. Each satellite covers a plurality of areas on the ground (called “footprints”) by means of a plurality of beams with different carrier frequencies, and these footprints move as the satellite moves. As seen from the ground, the movement of the footprints means that the stations and the terminals must frequently switch beams and satellites, which makes the transmission system very complex. Also, the bandwidth of the communication link between a station and a satellite must be very large, with the result that the bandwidth that can be transmitted between a station and an associated terminal is relatively small.

The present invention, on the other hand, concerns a system in which switching between links is considerably reduced and which enables the use of a greater number of more directional beams, allowing broadband links between stations and terminals.

### SUMMARY OF THE INVENTION

This objective, and others, are achieved by a communication system comprising a set of non-geostationary satellites setting up communication links between ground stations and terminals, a link from a station terminating at associated terminals located in a limited geographical area including said station, wherein a communication link between a particular station and terminals associated therewith is set up by a satellite from said set of satellites which is commanded to set up to this end a steerable transmit beam and a steerable receive beam pointing towards said limited area including said particular station and supporting said communication link.

The use of steerable beams that do not move relative to the ground enables one satellite to set up and to maintain a communication link between a station and its terminals while moving from one horizon as seen from that station to the other horizon, i.e. for as long as possible, given that the satellites are non-geostationary, which contributes to reducing switching between links and therefore to improving overall transmission efficiency.

In one embodiment of the invention, said beams are set up in response to a command transmitted from said particular station to said satellite. Each station thus requests from the satellites in its view the beams that it needs in terms of frequency, bandwidth, shape and orientation.

Alternatively, said beams are set up according to data stored beforehand in said satellite and used as the satellite progresses around its orbit.

Alternatively, said beams are set up according to data stored beforehand in the station and supplied to the satellite as it progresses around its orbit.

In the first embodiment mentioned above, a satellite being in view of said particular station, the latter is adapted to command it to set up a link, which entails transmitting station identifying data and beam set-up command data, the satellite being adapted to verify that the station belongs to the system and to set up the requested beams accordingly.

Likewise, a satellite being in view of said particular station, the latter is adapted to send it a link clearing down command, which entails transmitting to it station identifying data and beam clearing down command data, the satellite being adapted to verify that the station belongs to the system and to clear down the beams set up for its use accordingly.

In the system of the invention, each station comprises at least two directional antennas of which one is pointed at the satellite by which a communication link is set up for its use.

Likewise, each terminal comprises at least one directional antenna that is pointed at the satellite which sets up a communication link aimed at it.

Said satellite is commanded to set up said beams only outside a celestial area in which the system might interfere with other space communications.

Indeed the problem of frequency allocation is well known in this technique. A number of potential users are always seeking frequency resources. Regulatory authorities assign the available resources. Then other users should respect the allocated and assigned frequency resources, as well as the related frequency sharing constraints.

The above feature, while permitting another user to exploit already allocated frequency resources, provides for the respect of the existing allocation and assignments.

This may advantageously apply to the frequencies allocated to space networks.

To be more precise, the communication system of the invention includes means for preventing harmful interference, including interference data defining, or enabling definition of, for each satellite and with respect to each station, at least one time interval in which setting up a communication link is allowed or, reciprocally, at least one time interval in which setting up a communication link is not allowed, these interference prevention means comprising control means conditioning the decisions to set up and/or to clear down beams between the satellite and the station in question by prohibiting the setting up or the maintaining of a communication link that might interfere with other space communications.

In one embodiment, said interference data is included in a table incorporated into each station and, if necessary, consulted by said control means during pointing of its antenna to prevent pointing it in a direction such that the system might interfere with other space communications.

In another embodiment, said interference data is included in a table incorporated into each satellite and consulted at the time of beam pointing to prevent pointing of beams in a direction such that the system might interfere with other space communications.

In combination, the provisions just mentioned are redundant; they enhance the security of the system, however, and guarantee that the system of the invention will not interfere with geostationary satellite communication systems.

In either of the above two cases, said table is preferably downloaded from a command center which also supplies said pointing data to the stations and/or to the satellites.

Finally, the satellites can be in an orbit such that their track on the ground closes upon itself after a particular number of revolutions. This simplifies the ephemeris in the stations and the terminals.

The invention further consists in a station, a terminal and a satellite adapted to be used in the communication system as just defined.

The various objects and features of the invention will now be described in detail in the following description of one embodiment of the invention given by way of non-limiting example and with reference to the appended drawings.

### BRIEF DESCRIPTION OF THE DRAWINGS

FIG. 1 is a diagrammatic view of a communication system in accordance with the invention.

FIG. 2 shows one possible track, projected onto the surface of the Earth, of satellites suitable for implementation of the invention.

FIG. 3 is a diagram illustrating frequency re-use in the FIG. 1 system.

FIG. 4 is a block diagram of one implementation of the equipment on board a satellite of the FIG. 1 system.

FIG. 5 is a block diagram of the equipment of a station or a terminal of the FIG. 1 system.

FIG. 6 is a block diagram of one implementation of the equipment on board a satellite of the FIG. 1 system with additional means allowing re-use of geostationary satellite communication system frequencies.

FIG. 7 is a block diagram of the equipment of a station or a terminal of the FIG. 1 system with additional means allowing re-use of geostationary satellite communication system frequencies.

FIG. 8 shows on example of the content of the data tables 52 and 82 from FIGS. 6 and 7, respectively.

### DETAILED DESCRIPTION OF THE PREFERRED EMBODIMENT

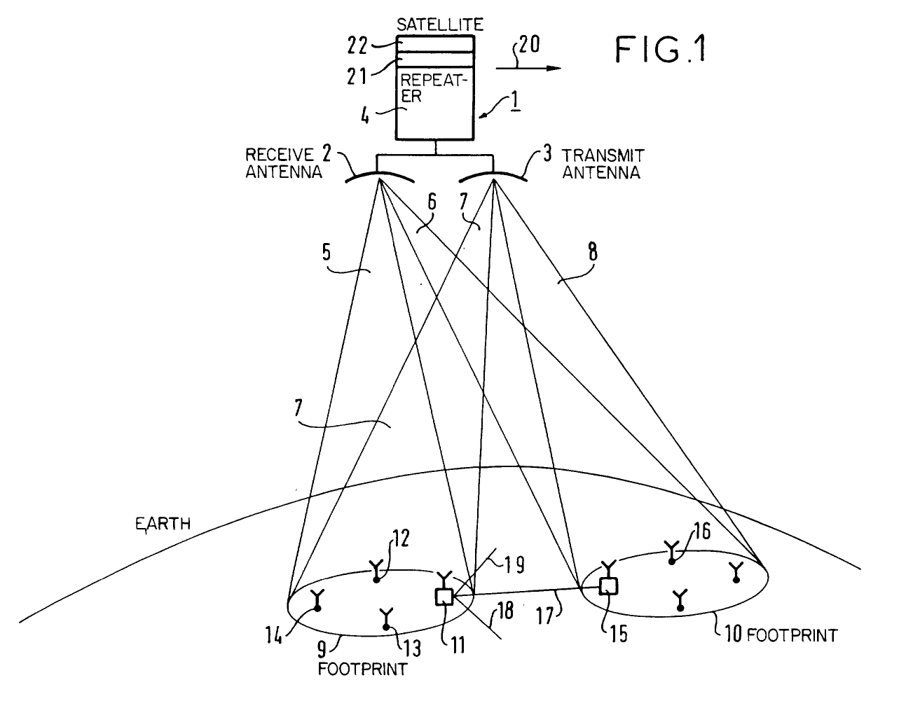

FIG. 1 is a highly schematic representation of the satellite communication system of the invention. It comprises a set of non-geostationary satellites, of which the figure shows only one satellite 1. It has a receive antenna 2 and a transmit antenna 3, between which is a repeater 4. Signals received from the Earth via the receive antenna 2 are amplified in the repeater 4 and retransmitted towards the Earth via the transmit antenna 3. Thus from the call management point of view the satellite 1 is transparent. It merely constitutes a relay station between sources and recipients of signals which are both on the ground. This reduces the cost of the space segment.

To be more precise, the antennas 2 and 3 each generate a multiplicity of beams. The antenna 2 generates uplink beams including the beams 5 and 6, for example. Likewise, the antenna 3 generates downlink beams including the beams 7 and 8. The beams can have different characteristics (frequency, polarization, bandwidth, etc). Array antennas can be used. A description of such antennas can be found in the article “A Ku Band Antenna Program” by D. Michel et al published in the minutes of the “15th International Communications Satellite Systems Conference”, organized by the AIAA, Feb. 27 through Mar. 3, 1994, or in the article “Antenne active de télémesure, charge utile pour satellite d'observation en orbite basse” (“Active telemetry antenna, payload for low Earth orbit sensing satellite”) by F. Magnin et al, GINA 94. An uplink beam, the beam 5 for example, and a downlink beam, the beam 7 for example, have the same “footprint” (limited geographical coverage area) 9 on the surface of the Earth. Likewise, the beams 6 and 8 have a common footprint 10.

An area like the area 9 includes a station 11 and terminals 12, 13, 14. The idea is that the station 11 communicates with the terminals 12, 13, 14 via a satellite 1 the transmit and receive beams of which cover an area 9 that contains the station and the associated terminals. The signals transmitted by the station are relayed to the terminals by the satellite. Likewise, the signals transmitted by the terminals are relayed to the station by the satellite. This sets up a communication link between them. The same applies in the case of the area 10 containing a station 15 and terminals 16 that communicate with each other in the manner just explained.

The communication link between a station of this kind and the associated terminals can be operated in a similar way to terrestrial mobile telephone systems, for example; the communication link then provides a plurality of different frequency channels, at least some of these channels being time-division multiplexed to carry more than one call. The terminals call the station on an access channel common to them and the station responds on a control channel. Conflicts for access to the access channel can be managed by a conventional procedure of the “ALOHA” or “slotted-ALOHA” type. The control channel assigns a time slot in each transmission direction between a terminal and the station. Communication can then take place, for example between the terminal 14 and the station 11. The latter can connect the terminal 14 to another terminal, for example the terminal 12, using similar means. It can also extend the call to other stations, for example the station 15, over links 17, 18, 19, or to other networks, depending on the site to which another terminal that the terminal 14 is requesting to access is connected.

The links between stations can be terrestrial links or satellite links. The same satellites can be used for this purpose. They then carry an additional communications system, similar to that of the invention, reserved for communications between stations and rated accordingly. The footprints will be fairly large, in order to include a plurality of stations.

The communication link between the station 11 and the associated terminals 12, 13, 14, the satellite being transparent, is therefore a multiplexed link from the station to all the terminals. It may comprise one or more different frequency channels and on each of these one or more time-division multiplex channels, for example asynchronous time-division multiplex channels. In the context of the present invention, suffice to say that techniques that are well known and proven in the field of terrestrial communications are used.

In the system of the invention, the satellite 1 is a non-geostationary satellite which moves as shown by the arrow 20. To be aimed at all times at the areas 9 and 10, the beams 5 through 8 must be pointed at those areas and track them. To this end the satellite 1 includes a beam pointing device 21 comprising a table that is read periodically and provides coordinates for pointing the beams as the satellite moves so that the beams remain pointed at the areas 9 and 10 for as long as the satellite 1 is in view of the latter. Array antennas of the type previously mentioned meet this requirement.

The satellite 1 will finally cease to be visible from the area 9, for example. Before this happens, the beams 5 and 7 must be turned off. Another satellite, similar to the satellite 1, is used instead of the satellite 1 to maintain the communication link between the station 11 and the terminals 12, 13, 14 by means of beams similar to the beams 5 and 7. This will come about in just the same manner as when the satellite 1 previously came into view of the areas 10 and 9.

To this end, in accordance with the invention, the satellite comprises beam set-up means 22 to set up beams adapted to carry the communication links needed for the areas overflown by the satellite.

In a first embodiment of the invention, each station, knowing the route of the satellite 1, requests the satellite, on rising above the horizon, to set up the links that it needs. Thus, seeing the satellite 1 rise above the horizon, the station 11 sends it a message on a control channel, not shown in FIG. 1, to the beam set-up means 22 to cause the satellite to set up the beams 5 and 7. Interconnected by the links 17, 18, 19, the various stations like the station 11 coordinate their connection requests beforehand, allowing for the communication capacity of the satellite, so that the needs of the various stations can always be met.

The station 11 is additionally adapted to command linking up to the satellite 1 by transmitting to the satellite data which identifies the station and specifies the beams to be set up; the satellite is adapted to verify that the station belongs to the communication system and to set up the requested beams accordingly. This is to protect against fraudulent access to the satellite.

In one variant, the beams are set up on the basis of data stored in the satellite beforehand and used as the satellite progresses around the Earth.

In another variant, the data is stored in the stations and supplied to the satellite as it progresses.

The communication system of the invention comprises a set of satellites capable of providing at all times the communication links required by each station to communicate with the associated terminals in its area. To provide a permanent service each station must be able to see at all times at least one satellite capable of providing it with a communication link with the associated terminals and a second satellite rising above the horizon before that through which it is linked to its terminals has moved too far away.

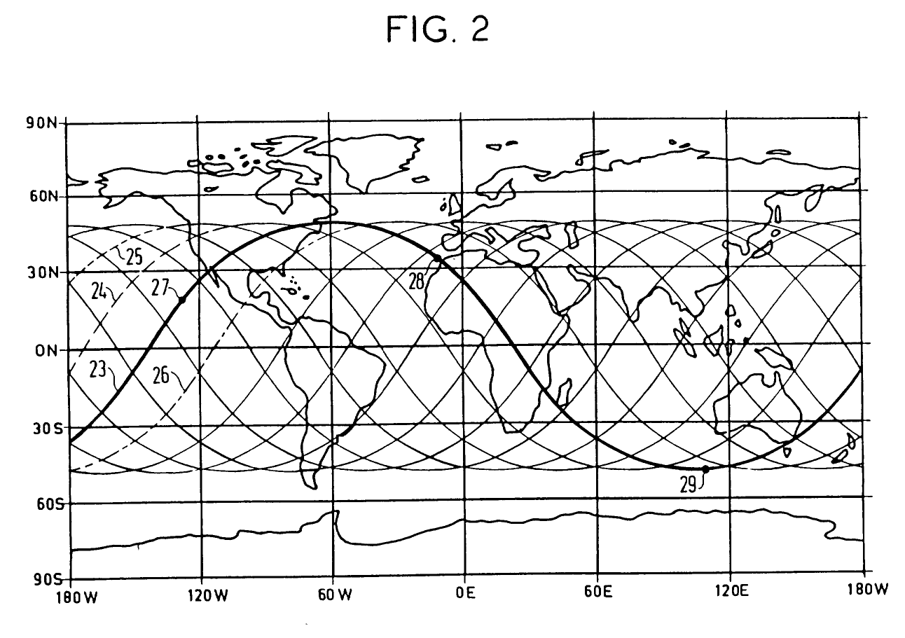

In one embodiment these satellites are in circular orbits at an altitude of 1 626.5 km and an inclination of 55°. FIG. 2 shows the track on the ground of an orbit of this kind. Because of the rotation of the Earth and natural precession due to the flattening of the Earth, this track closes upon itself after 12 revolutions. This simplifies the pointing of the antennas, which is of particular importance with regard to the antennas of the terminals. FIG. 2 shows the tracks 23 through 26 after which a satellite returns to its point of departure. In one embodiment of the satellite system there is a plurality of regularly spaced orbits with a track similar to that of FIG. 2. The phase of the satellites in each orbit is synchronized to those on either side of it so that the distribution of the satellites is regular and, seen from a ground station, the satellites always follow the same path.

Each satellite sets up a maximal number n of uplink beams and the same maximal number n of downlink beams. Each beam covers a footprint (area on the ground) with a radius of approximately 200 km. Implementation can be progressive. A first configuration provides complete coverage in temperate latitudes. A second covers the whole planet between 80°S. and 80°N. In sparsely populated regions beams with a greater coverage can be used, for example beams with a footprint diameter of 500 km.

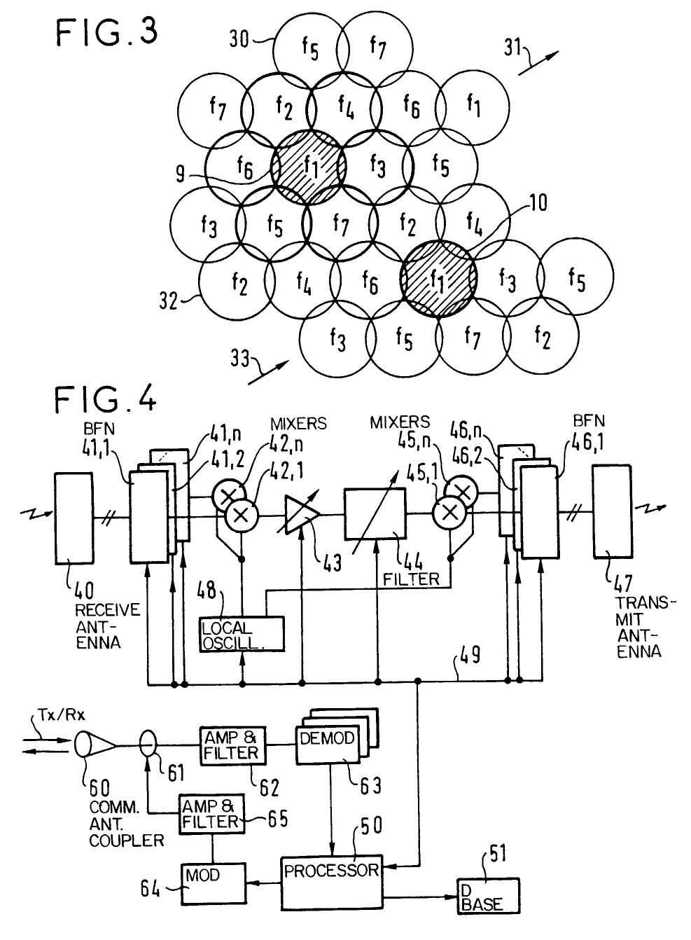

Each area is allocated its own receive frequency for each transmission direction, for example from the satellite to the ground. The receive frequencies of neighboring areas are different. Nevertheless, the total number of frequencies used by the system can be quite small. For example, FIG. 3 shows a well-known arrangement of areas 30 forming a regular mesh covering all of a region. The frequencies specific to each area are shown. There are seven frequencies f1 through f7. Areas 9 and 10 from FIG. 1 are shown again in FIG. 3. In this example, they use the same frequency f1. The same arrangement is used in the uplink direction.

In a different embodiment each area is assigned a transmit/receive time slot in a frame comprising seven such time slots t1 through t7, for example, during which all of the available frequency band can be used, using the beam hopping technique.

Seen from a ground station, the satellites move across the sky in paths that repeat. A simplified ephemeris can therefore be used to define those paths, which facilitates the calculations to be carried out in each station and in each terminal.

As will emerge below, the communication link set up for a station by a satellite comprises not only a beam pointed by the satellite towards the area containing the station, as shown in FIG. 1, but also a beam pointed by the station towards the satellite, for uplink transmission and downlink transmission on the communication link. The station preferably uses high-gain antennas and each station comprises at least two antennas, one used for the “serving” (active) communication link and the other preparing for setting up of the communication link via another satellite. The terminals can have one or more small antennas, of limited directionality, which facilitates pointing them towards the satellites.

Turn now to FIG. 4, which is a block diagram of one embodiment of the equipment on board a satellite of the communication system of the invention, for example the satellite 1 from FIG. 1.

For communication between stations and the terminals the satellite essentially comprises a repeater system including:

a receive antenna 40,

a plurality of receive beam forming networks 41.1 through 41.n,

a plurality of receive mixers 42.1 through 42.n,

for each such frequency shifted channel, a variable gain amplifier 43 driving a variable bandwidth filter 44,

a plurality of transmit mixers 45.1 through 45.n,

a plurality of transmit beam forming networks 46.1 through 46.n,

a transmit antenna 47,

a local oscillator 48 supplying the transmit mixers and the receive mixers with frequencies for transposing the communication channels from the uplink frequency band to a lower intermediate frequency for optimum amplification and filtering of the signals followed by transposition of the communication links into the downlink frequency band.

A bus 49 connects the beam forming networks, the mixers, the amplifiers and the filters to a processor 50 supplying the necessary control information to all these items.

The antenna 40 is an array antenna of the type described in the documents previously mentioned; with the beam forming networks 41.1 through 41.n it produces n beams. Its bandwidth covers the seven frequency bands used to cover the various areas (or all of the band if beam hopping is used).

The signal on the beam formed by the network 41.1 from the station and the terminals of a given area to which this beam is pointed is transposed into the intermediate frequency band by the mixer 42.1, the local oscillator 48 supplying the appropriate frequency. After amplification in the amplifier 43 with the gain set by the processor 50, the filter 44 selects the frequency band required for the area in question. The resulting signal is transposed into the downlink frequency band in the mixer 45.1, using the frequency supplied by the local oscillator 48. The resulting signal is fed to the beam forming network 46.1 and the corresponding energy is directed by the antenna 47 towards the same area. These means define a communication link in relation to that area.

It is therefore clear that the two beam forming networks 41.1 and 46.1 of the same communication link produce beams having the same orientation. They receive the same pointing information from the processor 50 which obtains this information from a database 51 having a slot for each footprint containing data for localizing that footprint relative to the satellite at all times and thus defining the orientation required of the satellite antenna beams to reach that footprint. This information is passed to the networks 41.1 and 46.1 which use it to orient the beams. The processor is adapted to consult the database periodically; on each occasion new pointing information is sent to the networks 41.1 and 46.1, which modify the pointing of the beams accordingly. The database does not need to be addressed very frequently.

As an alternative, this information can be supplied direct to the satellite by the ground station as and when the satellite needs it.

Of course, what has just been explained with reference to one communication link is equally valid for each of the communication links that the satellite can set up simultaneously. The processor supplies pointing and other information to the corresponding units in the same manner, on a time-sharing basis.

Of course, the satellite sets up only those communication links that are needed, and each of these with the requested power and bandwidth. Accordingly, it clears down any communication link that is not needed, either because the footprint for which that link was set up is no longer in view or because it is served by another satellite.

In accordance with the invention, the satellite is commanded to set up communication links by transmitting to it data that establishes and updates the database 51.

To this end, the satellite comprises, in cascade:

a command antenna 60,

a coupler 61,

a receive amplifier and filter subsystem 62,

a demodulator 63, and, also in cascade:

a modulator 64, and

a transmit amplifier and filter subsystem 65 driving the coupler 61.

A command data source in view of the satellite can therefore transmit to it command data on a command frequency that the satellite receives, amplifies and demodulates, the output of the demodulator 63 supplying the data in question to the processor 50 which compares it with the database 51.

The command data source must dialog with the satellite and in particular it must identify itself. As more than one station may wish to dialog with the satellite at the same time, an access procedure must be adopted that can manage such conflicts. An ALOHA type procedure similar to that previously mentioned can be used here also.

In a first form of the communication system of the invention, the data stored in the database 51 comes from a single master station; it is updated regularly. This data is used to set up and to clear down communication links and accordingly provides the beam pointing information. The stations register the setting up and the clearing down of communication links by the satellite overflying them. They use communication links set up by the various satellites, switching from one to another as and when required. In each station the data for tracking the satellite and switching the communication link from one satellite to another is also supplied by a master station of the communication system.

In another form of the communication system of the invention the data concerning each communication link is transmitted to the satellite by the station requesting the link when the station sees the satellite approaching. In response, the satellite sets up the communication link requested. The same means are used to enable a station to command the clearing down of a communication link. The role of the satellite in relation to the data of the database 51 is then more passive than in the first form of the system, since it merely has to execute commands to set up and to clear down communication links, the database 51 merely supplying authenticating data and pointing information.

In a further form of the system, the data concerning each communication link is transmitted to the satellite by the station that requested the link whenever the satellite needs it. The database 51 then has no function other than authentication, its content being in the databases of the stations (see below).

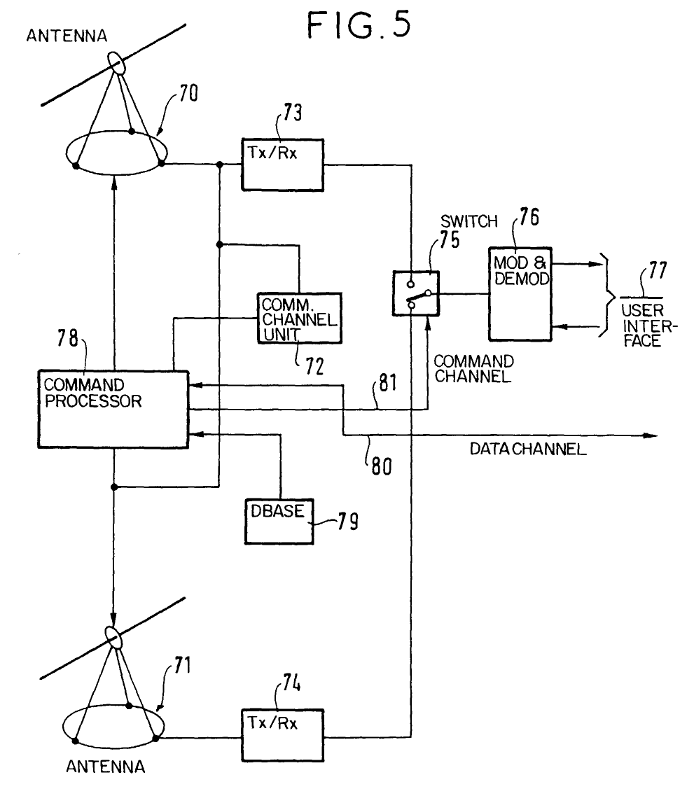

Turn now to FIG. 5, which is a highly schematic representation of one embodiment of the transmission equipment of a ground station, in this case a station with two antennas.

The station in FIG. 5 therefore comprises two antennas 70 and 71 each connected to a respective transmit/receive subsystem 73, 74 one of which is connected via a changeover switch 75 to a modulator/demodulator subsystem 76 connected to a user interface 77. The two antennas are steered by a command processor 78 using for this purpose a database 79 like that described in connection with the satellite with reference to FIG. 4.

The processor 78 communicates in both directions with a master station via an additional data channel 80, the master station supplying it with data to be stored in the database 79, for example. As previously mentioned, this data channel can be set up via the satellites of the communication system, which are provided with additional means to this end.

The processor 78 and the database 79, as described for the processor 50 and the database 51 in FIG. 4, steer the beams from the antennas 70 and 71 towards first and second satellites, respectively. One of the two satellites sets up a communication link for the station in question, that at which the antenna 71 is aimed, for example, and the switch 75 is set accordingly, as shown in FIG. 5, under the control of the processor 78, via a command channel 81.

In this way the station 11, for example communicates via the user interface 77 with the satellite and, since the satellite is transparent from the communication point of view, via the satellite with the terminals of its area.

When the first satellite moves away, the changeover switch 75 is switched to the antenna 70 which is pointed at a second satellite that will be used to provide the communication link in place of the first.

The station additionally has a command channel unit 72 coupled to the antenna 70 or 71 steered by the processor 78 for transmitting data to the satellite. The station transmits command data to the satellite one the command channel, as previously described.

Command data reaching the station via the link 80 is first stored by the processor 78 in the database 79 which therefore contains not only the command data it needs to acquire and track the satellites of the communication system but also the data to be transmitted to the satellites.

The station in FIG. 5 can therefore act as the master station and transmit a complete set of command data to each of the satellites of the system.

Each of the stations similar to that of FIG. 5 can be restricted to transmitting to each satellite with which it communicates the data enabling it to set up a communication link for it.

In this case, the station must also transmit a command to clear down the link at a later time.

Alternatively, the command link supplies the satellite with command data from the database 79, as and when it needs it, as it progresses in its orbit.

There is no specific figure to illustrate the terminals. FIG. 5 applies equally to a terminal.

The latter has one or two steerable antennas, one or two receive subsystems and a transmit subsystem. The user interface delivers the entire spectrum of the communication link. The communication channel used by the terminal to communicate with the station is determined by communication procedure described above and which is in any event outside the scope of the present invention.

Likewise, the terminal has a processor and a database for pointing its antenna(s) as previously specified. The data stored in its database is transmitted to it by the associated station via the command link 82 or the like.

Of course, the system just described can easily be extended so that a station uses more than one satellite at a time to communicate with the associated terminals. The stations (see FIG. 5) must have more than two transmit-receive subsystems 70, 73 and the switch 75 is more complex, to connect (for example) two of three active subsystems to two modulator-demodulator subsystems 76.

In the opposite direction, the system just described applies equally well to situations in which the stations and/or the terminals have only one antenna, an electrically pointed antenna, for example, enabling them to switch from one satellite to another with no significant impact on calls.

A final feature of the communication system of the invention is that, as seen from the ground, the satellites appear as sources that are turned on and off in accordance with the communication needs of the station. It is also necessary to take into consideration other sources in the form of the satellites of other existing or future communications systems. The system of the invention can turn off the beams of a satellite whose position in the sky might cause interference with other space communications. It then becomes possible to use for the communication system of the invention a frequency allocated to said other space communications, or even only such frequencies.

Indeed the problem of frequency allocation is well known in this technique. A number of potential users are always seeking frequency resources. Regulatory authorities assign the available resources. Then other users should respect the allocated and assigned frequency resources, as well as the related frequency sharing constraints.

The above feature, while permitting another user to exploit already allocated frequency resources, provides for the respect of the existing allocation and assignments.

This may advantageously apply to the frequencies allocated to space networks.

An example of the above will be given with particular reference to communication via geostationary satellites using frequencies in the Ka or Ku band. Uplink and downlink communications between a geostationary satellite and a ground station are directional, even if the directionality is weak, as in the case of direct broadcast satellites broadcasting TV programs. The antennas of the ground stations are pointed at the satellites in geosynchronous orbits; the antennas of the stations in a given area are therefore all pointed towards an arc across the sky. A “no go” area for the system of the invention is therefore defined around the geostationary arc, calculated in accordance with the directionality of the antennas, the powers employed and the coordination threshold that is not to be exceeded (for example ±10° about the geostationary arc). Any source transmitting on geostationary satellite frequencies in this arc could be received by one or more stations and this could constitute interference. On the other hand, any source outside this arc and transmitting on these frequencies would not interfere with the stations of the geostationary communication system. It is therefore possible to construct a communication system using these frequencies provided that it is spatially separated from the geostationary communication system. This is what enables use of the invention subject to the provision of additional features such that no satellite of the system of the invention is able to set up a link to a cell on the ground when, as seen from that cell, it is within said arc. In the opposite communication direction, from the ground to the geostationary satellites, the invention prohibits the stations from transmitting towards the geostationary satellite. Ipso facto, the terminals do not transmit in this direction either.

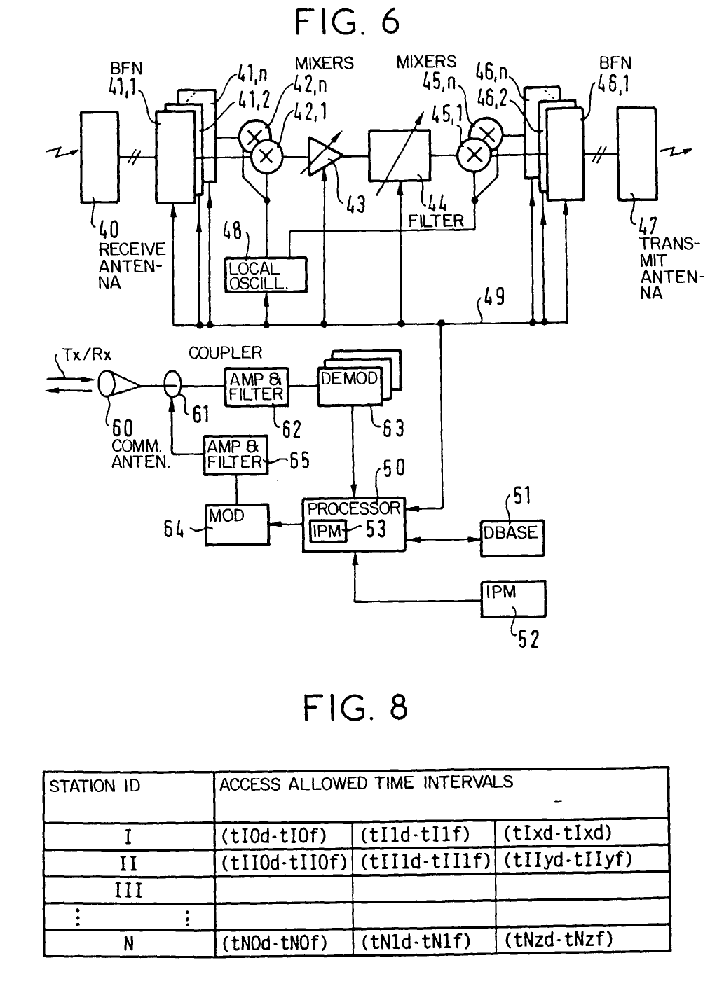

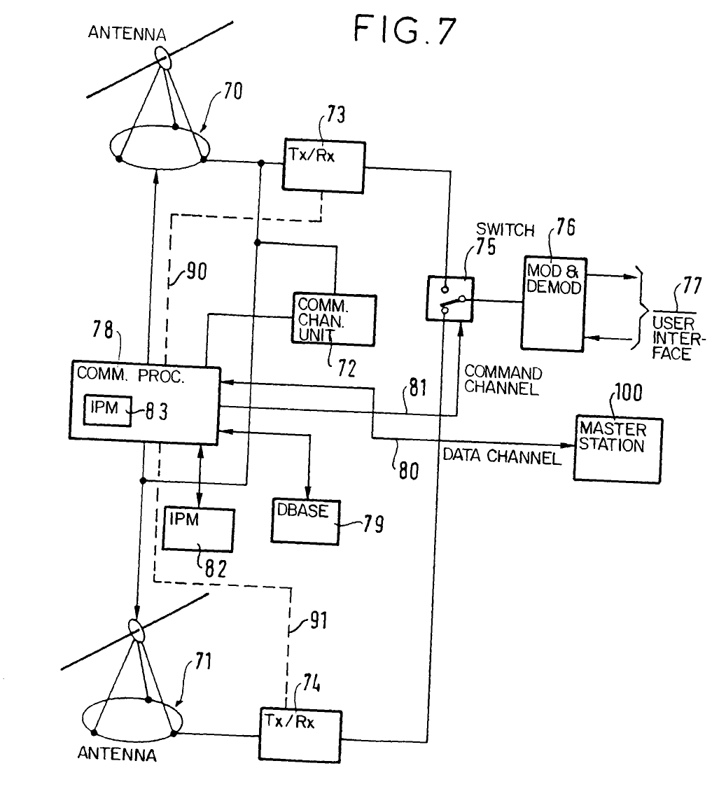

The system of the invention, as just described, in which beam set-up and clearing down are commandable, readily lends itself to the implementation of this concept. A description of this will be given with reference first to FIGS. 6 and 7.

FIG. 6 shows the equipment on board a satellite of the communication system of the invention, together with interference prevention means, and contains all the items from FIG. 4, which are identified by the same reference numbers. They will not be described again. The only additional items are interference prevention means 52, 53 containing interference data defining or used to define, for each satellite and with respect to each station, at least one time slot in which the setting up of a communication link is allowed or, reciprocally, at least one time slot in which the setting up a communication link is not allowed, the interference prevention means comprising control means conditioning the decisions to set up and/or to clear down beam between the satellite and the station in question to prohibit the setting up or the maintaining of a communication link that might interfere with other space communications.

To be more precise, the interference prevention means comprise a memory 52 containing a table containing certain interference data and consulted by a control device 53 incorporated in the command processor 50 of the satellite at the time of beam pointing, if necessary, to prevent pointing of the beams in a direction such that the system might interfere with space communications.

The data in the memory 52 is downloaded, like the data in the memory 51, or can be calculated on board. It contains interference data having the format shown in FIG. 8, for example. This shows that, for each of the ground stations I through N, the table defines (for station I, for example) a time interval tI0d-tI0f specified by a start time tI0d and an end time tI0f, and other like time intervals tI1d-tI1f through tIxd-tIxf. The same goes for all the other stations II through N of the communication system, substituting II through N for I and the number of time intervals defined being v through z. These time intervals are those during which setting up of beams towards the cell containing the identified station is allowed. On the other hand, the same table defines the time intervals during which such beams must not exist, regardless of the reason, in particular when they might interfere with another satellite communication system, for example a geostationary satellite communication system. At the time of setting up beams, the row of the table corresponding to the station and therefore to the cell on the ground to which the beams will point is consulted. The time of day available on the satellite in the conventional way is compared by the device 53 with the time intervals that this row contains.

If the time of day is within one of the “allowed” time intervals, setting up of the beams is allowed. The beam setting up command is executed. The processor 50 communicates to the station that requested the beams the end time of the authorized time interval. The station can compare this information with the beam use end time that it holds itself, to verify that it can retain the beams in question for as long as it intends to, or to give an alert otherwise.

If the time of day is not in one of the “allowed” time intervals defined by the FIG. 8 table, the command is not executed and an error message is sent by the processor 50 over the command link comprising the units 64, 65, 61, 60 to the station that generated the command, so that an alert can be given and the back-up procedure initiated. This procedure is beyond the scope of the invention. The same would apply if the request were submitted near the end of the authorized time interval.

Turn now to FIG. 7 showing the equipment of a station or a terminal as shown in FIG. 5, with the addition of interference prevention means 82 similar for the most part to the memory 52 in FIG. 6. In particular, the content of the memory 82 can be structured differently from that shown in FIG. 8. The station uses the memory 82 to create each beam above its area. The command center advantageously supplies the data in the tables 82 and 52 downloaded in the same way as the tables contained in the memories 51 and 79, in the satellites, in the stations and in the terminals.

The station also receives error messages and authorized interval end time messages. The processor is adapted to process these messages, primarily by transmitting them to the command center, and, if necessary, to implement correction procedures.

It is in fact the command center which, by loading the tables 51, 52, 79 and 82, commands space segment operations at the stations, at the terminals and on the satellites which control the communication links, i.e. (for the satellites) which beams it can provide (frequency, gain, pointing, start time and end time), and (for the stations and the terminals) which satellite to aim at (pointing, start time and end time).

In the situation discussed above with reference to FIG. 2, the tables in question can be semi-permanent; they change only if the satellite system is modified.

On the other hand, the invention would apply equally well to satellites in non-resonant orbits; in this case the tables must be periodically reloaded or recomputed and contain the information needed for the period between two operations that load the tables. This period can be in the order of one month using current memory technologies.

The terminals do not need this information, which can be replaced by a simple semi-permanent ephemeris in the terminals defining the paths of the satellites in service. Each terminal can be adapted to receive from its own station, while communicating with a satellite, the identity of the next satellite to be used to continue the call. The ephemeris is used to acquire and to track this satellite. When a terminal is switched on, this table is systematically searched to enable the terminal to attempt to enter into communication via each of the satellites in view, until it finds a satellite that has set up beams for the cell in which it is located.

This centralized control of the communication network takes account of what has just been explained with reference to preventing interference with an existing geostationary communication network.

The FIG. 8 table, used in a satellite, ensures that the system of the invention cannot interfere with the geostationary communication system.

Likewise, the content of the table 82 in each station guarantees that the system of the invention cannot interfere with the geostationary communication system. It can be considerably simpler than that shown in FIG. 8. For example, the table 82 can contain the angular description of a celestial arc into which the antennas of the station must not point.

When a beam is opened up, the station receives a message from the satellite telling it until when the satellite can maintain the beams to the station. This information must be compared to the contents of the databases 79 and 82 to verify that this limit is outside the tracking time of the satellite concerned. If not, an error message must be transmitted.

To prevent harmful interference with geostationary systems it is sufficient to use only the tables on the satellites or only the tables in the stations. Joint use of both types of table as described above makes the system more secure, however.

The pointing of the terminal antennas is commanded by the command center, in the manner described for the stations. Verification of the absence of transmission in said celestial arc is also desirable, but not indispensable. The terminals transmit only when they identify a signal from a satellite of the system of the invention: there is therefore no risk of their transmissions interfering with geostationary communications. However, application of the above provisions can lead to a specific problem in that, although its antenna does not point into the above celestial arc, but is merely close to the latter, the uplink transmission from the terminal to the satellite of the system of the present invention can suffer interference from a neighboring powerful station of a geostationary communication system. Means are therefore additionally provided in the terminals to bring about a temporarily limited increase in their transmit output power, at the request of the station with which they are communicating, if the call is affected by interference. These means are shown in FIG. 7 by the connections 90 and 91 between the processor 78 and the transmit-receive subsystems 73 and 74. When the processor 78 receives a command from the associated station the transmit level of the terminal via the active subsystem is increased by a predetermined amount, for example 6 dB, to improve the signal to interference ratio at the satellite. If this increase in power is not sufficient, the terminal can reduce its data rate, in order to improve communication quality. An alternative is to allocate a terminal another frequency, avoiding the interference. The same arrangements can be adopted in other cases of interference with transmission to the satellite. This increase in the transmit level is naturally not sufficient to cause interference with the geostationary communication system.

The system for preventing harmful interference with or by geostationary satellite systems enabling re-use of the transmission frequencies of such systems is applicable to communication with terminals on the ground, identify a signal from a satellite of the system of the invention: there is therefore no risk of their transmissions interfering with geostationary communications. However, application of the above provisions can lead to a specific problem in that, although its antenna does not point into the above celestial arc, but is merely close to the latter, the uplink transmission from the terminal to the satellite of the system of the present invention can suffer interference from a neighboring powerful station of a geostationary communication system. Means are therefore additionally provided in the terminals to bring about a temporarily limited increase in their transmit output power, at the request of the station with which they are communicating, if the call is affected by interference. These means are shown in FIG. 7 by the connections 90 and 91 between the processor 78 and the transmit-receive subsystems 73 and 74. When the processor 78 receives a command from the associated station the transmit level of the terminal via the active subsystem is increased by a predetermined amount, for example 6 dB, to improve the signal to interference ratio at the satellite. If this increase in power is not sufficient, the terminal can reduce its data rate, in order to improve communication quality. An alternative is to allocate a terminal another frequency, avoiding the interference. The same arrangements can be adopted in other cases of interference with transmission to the satellite. This increase in the transmit level is naturally not sufficient to cause interference with the geostationary communication system.

The system for preventing harmful interference with or by geostationary satellite systems enabling re-use of the transmission frequencies of such systems is applicable to communication with terminals on the ground, a satellite setting up a communication link with terminals in a limited terrestrial area via a steerable transmit beam and a steerable receive beam pointing towards said limited area including said terminals and supporting said communication link. In other words, it is not necessary for there to be a station in the sense as described previously, either because the terminals communicate directly with each other or because the station, or its counterpart, is not in the cell. Using the means previously described (tables 52 and 82 in FIGS. 6 and 7), the satellites will not transmit under conditions likely to cause interference with geostationary communications. The terminals transmit only when they identify a signal from a satellite: there is therefore no risk of their transmissions interfering with geostationary communications.

There is claimed:

1. Communication system comprising a set of non-geostationary satellites setting up communication links between ground stations and terminals, a link from a station terminating at associated terminals located in a limited geographical area including said station, wherein a communication link between a particular station and terminals associated therewith is set up by a satellite from said set of satellites which is commanded to set up to this end a steerable transmit beam and a steerable receive beam pointing towards said limited area including said particular station and supporting said communication link.

2. Communication system according to claim 1 wherein said beams are set up in response to a command transmitted from said particular station to said satellite.

3. Communication system according to claim 1 wherein said beams are set up on the basis of pointing data stored in said satellite beforehand and used as the satellite progresses in its orbit.

4. Communication system according to claim 1 wherein said beams are set up on the basis of pointing data stored in said station beforehand and supplied to said satellite as it progresses in its obit.

5. Communication system according to claim 1 or claim 2 wherein, a satellite being in view of said particular station, said particular station is adapted to command it to set up a link by transmitting it station identification data and beam set-up command data, said satellite being adapted to verify that said station belongs to said system and to set up the requested beams accordingly.

6. Communication system according to claim 1 or claim 2 wherein, a satellite being in view of said particular station, said particular station is adapted to command it to clear down a link by transmitting it station identification data and beam clearing down command data, said satellite being adapted to verify that said station belongs to said system and to clear down the beams set up for it accordingly.

7. Communication system according to claims 5 and 6 wherein said particular station is adapted to detect the coming into view of satellites of said system and to predict their disappearance from view in order to decide at all times via which satellite in view it must be connected and for consequently transmitting to the satellites in view link setting up and clearing down commands, in order to remain in communication with said terminals in its area.

8. Communication system according to any one of claims 1 to 6 wherein each station comprises at least one directional antenna adapted to be pointed towards a satellite by which a communication link is set up for it.

9. Communication system according to any one of claims 1 to 6 wherein each station comprises at least two directional antennas of which one is in service and is pointed to a satellite by which a communication link is set up for it leaving the other free to be pointed towards a satellite which will provide said communication link subsequently.

10. Communication system according to claim 8 or claim 9 wherein each terminal comprises at least one directional antenna adapted to be pointed to a satellite by which a communication link pointed at it is set up.

11. Communication system according to claim 10 wherein said satellite is commanded to set up said beams only outside a celestial area in which the system might interfere with other space communications.

12. Communication system according to claim 11 wherein said satellite transmits on at least one frequency allocated to said other space communications.

13. Communication system according to claim 12 including interference prevention means containing interference data defining or used to define, for each satellite and concerning each station, at least one time interval in which setting up a communication link is allowed or, reciprocally, at least one time interval in which setting up a communication link is not allowed, said interference prevention means comprising control means conditioning decisions to set up and/or to clear down beams between said satellite in question and said station in question by prohibiting the setting up or the maintaining of a communication link that might interfere with other space communications.

14. Communication system according to claim 12 wherein interference data is included in a table incorporated into each station and consulted during pointing of its antenna in service in order to prevent pointing of said antenna in a direction such that the system might interfere with other space communications.

15. Communication system according to claim 13 wherein interference data is included in a table incorporated in each satellite and consulted by said control means at the time of creating beams in order to prevent them being pointed in a direction such that the system might interfere with other space communications.

16. Communication system according to claim 14 or 15 wherein said table is downloaded from a command center or computed on board.

17. Communication system according to claim 16 wherein said command center also supplies said pointing data to said stations and/or said satellites.

18. Communication system comprising at set of non-geostationary satellites setting up communication links with terminals on the ground, a satellite setting up a communication link with terminals located in a limited terrestrial area via a steerable transmit beam and a steerable receive beam pointing towards said limited area including said terminals and supporting said communication link, wherein said satellite is commanded to set up said beams only outside a celestial area in which the system might interfere with other space communications.

19. Communication system according to claim 18 wherein said satellite transmits on at least one frequency allocated to said other space communications.

20. Communication system according to claim 18 including interference prevention means containing interference data defining or used to define, for each satellite and in respect of each limited area, at least one time interval in which setting up a communication link is allowed, or reciprocally, at least one time interval in which setting up a communication link is not allowed, said interference prevention means operating at the time of setting up and/or clearing down beams between the satellite and the area in question.

21. Communication system according to claims 18 and 19 wherein interference data is included in a table incorporated in each terminal and read at the time of pointing its antenna in service in order to prevent pointing in a direction such that said system might interfere with other space communications.

22. Communication system according to claim 19 wherein said interference data is included in a table incorporated in each satellite and read at the time of creating beams to prevent them being pointed in a direction such that said system might interfere with other space communications.

23. Communication system according to claim 21 or claim 22 wherein said table is downloaded from a command center or computed on board.

24. Communication system according to claim 23 wherein said command center also supplies said pointing data to said stations and/or said satellites.

25. Communication system according to claim 20 or claim 21 wherein said terminals include means for temporarily increasing the transmit power, reducing the data rate or changing the transmit frequency so that the signals they transmit are not affected by interference.

26. Communication system according to any one of the preceding claims wherein said satellites are in an orbit such that their track on the ground closes upon itself after a particular number of revolutions.

27. Satellite for use in the communication system according to any one of claims 1 to 26.

28. Station for use in the communication system according to any one of claims 1 to 26.

29. Terminal for use in the communication system according to any one of claims 1 to 26.
